(19) United States
(12) Patent Application Publication
(10) Pub. No.: US 2007/0006069 A1
(43) Pub. Date: Jan. 4, 2007

(54) System and method for improved web portal design through control tree file utilization

(75) Inventors: Gregory Smith, Westminster, CO (US); Christopher E. Bales, Boulder, CO (US); Melissa Dawe, Boulder, CO (US); Jeffrey Mueller, Superior, CO (US); Christopher Jolley, Broomfield, CO (US); Shane Pearson, Boulder, CO (US); Skip Sauls, Longmont, CO (US); Scott Musson, Golden, CO (US); Robert Ritchy, Boulder, CO (US); James D'Ambrosia, Westminster, CO (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 11/167,382

(22) Filed: Jun. 27, 2005

(51) Int. Cl. G06F 17/00

(52) U.S. Cl. 715/513

(57) ABSTRACT

Embodiments provide methods and mechanisms for organizing portal content that can enable a newly created portal element, i.e., a subsection of a portal, to be persisted as an externally, self-contained entity that can be created for the element and referenced by a control tree for the portal. A control tree includes information organized hierarchically or otherwise that is used to control serving of portal content. Externally persisted self-contained entities can be created for many types of portal elements. This ability of embodiments to persist new content externally in self-contained entities can enable embodiments to provide easier division of labor during the creation of portal content and improved organization of web portals

### RELATED APPLICATIONS

The following commonly owned, co-pending United States patents and patent applications, including the present application, are related to each other. Each of the other patents/applications are incorporated by reference herein in its entirety:

U.S. patent application Ser. No. _{——————}, entitled SYSTEM AND METHOD FOR IMPROVED WEB PORTAL DESIGN THROUGH CONTROL TREE FILE MODIFICATION, by Gregory Smith et al., filed on _{——————}, (Attorney Docket No. BEAS-1636US0);

U.S. patent application Ser. No. _{——————}, entitled SYSTEM AND METHOD FOR IMPROVED WEB PORTAL DESIGN THROUGH CONTROL TREE FILE UTILIZATION, by Gregory Smith et al., filed on _{——————}, (Attorney Docket No. BEAS-1638US0);

U.S. patent application Ser. No. _{——————}, entitled SYSTEM AND METHOD FOR IMPROVED WEB PORTAL DESIGN THROUGH CONTROL TREE FILE CREATION, by Gregory Smith et al., filed on _{——————}, (Attorney Docket No. BEAS-1639US0); and

U.S. patent application Ser. No. _{——————}, entitled SYSTEM AND METHOD FOR A SUBSECTION DESIGNER, by Gregory Smith et al., filed on _{——————}, (Attorney Docket No. BEAS-1738US1).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to the design of web content. The present invention relates more particularly to systems and methods for improved web portal design through control tree file utilization.

### BACKGROUND OF THE INVENTION

In recent years, web portals have become increasingly popular as a mechanism for providing both general and personalized content. Web portals are web sites that provide access to various content and applications that are accessible to users from a single location. These portals enable users to easily utilize a wide range of static and interactive content.

As portals have increased in popularity, various programs and tools have been developed to create and modify portals. Due to the increasing complexity of portals, portal developers have begun to feel the need to work together to create and administer a given web portal. Conventional technologies, however, do not readily support organizing large portals into constituent subparts. Accordingly, these conventional approaches do not facilitate making organization and administration easier. For example, conventional approaches require developers to work from a single portal file, making it difficult for individual developers to make simultaneous changes to the portal.

What is needed is an improved method of organizing and administering portal content that enables easier collaboration in development and administration of a portal.

### BRIEF DESCRIPTION OF THE DRAWINGS

FIG. 1 illustrates an overview of example portal architecture in an embodiment.

FIG. 2 illustrates a structure of an example portal in an embodiment.

FIG. 3 illustrates a system for serving a portal in an embodiment.

FIG. 4 illustrates a graphical user interface for generating and modifying portal content in an embodiment.

FIG. 5 is a flow chart illustrating a process for generating a file containing a portal element in an embodiment.

FIG. 6 is a flow chart illustrating a process for rendering a portal from a control tree file in an embodiment.

FIG. 7 is a flow chart illustrating a process for generating a control tree file referencing external files in an embodiment.

FIG. 8 is a flow chart illustrating a process for generating a file containing a subsection of a portal in an embodiment.

FIG. 9 is a flow chart illustrating a process for modifying a subsection of a portal in an embodiment.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details are set forth to provide a thorough description of the invention. However, it will be apparent to those skilled in the art that the invention may be practiced without these specific details. In other instances, well-known features have not been described in detail so as not to obscure the invention.

In embodiments, there are provided mechanisms and methods for organizing portal content. These methods and mechanisms for organizing portal content enable a newly created portal element, i.e., a subsection of a portal, to be persisted as an external, self-contained entity that can be created for the element and referenced by a control tree for the portal. A control tree includes information organized hierarchically or otherwise that is used to control serving of portal content. Externally persisted self-contained entities can be created for many types of portal elements. This ability of embodiments to persist new content as external, self-contained entities can enable embodiments to provide easier collaboration among developers during the creation of portal content and improved organization of web portals.

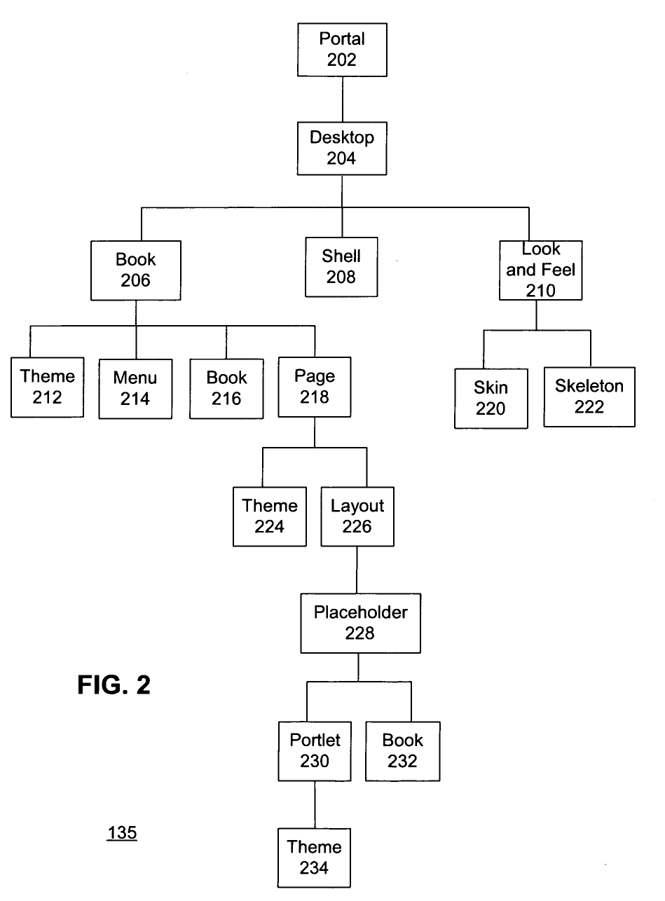

As used herein, the term “element” refers to a separately defined section of a portal and can include pages, books (groups of pages associated by a page navigation menu), menus, or any other separately definable part of a web portal. Some different types of elements and their relationships with one another are described below with reference to example embodiments as shown by FIG. 2.

The control tree is comprised of nodes. Typically, each node in the control tree corresponds to an element in the portal. The externally persisted portal content is referenced in one or more nodes of the control tree. In one embodiment, each node in the control tree can be a subclass of a control class.

As used herein, a “control tree document” is an entity that stores information used to create a control tree. In an embodiment, the control tree document is a structured document, such as an eXtensible Markup Language (XML) document, that includes instructions for generating the control tree for a portal. The control tree document may be persisted in a variety of ways, such as without limitation, a file or files, databases, relational, object and others, in memory data structures, objects, distributed objects and the like. A server, for example, can utilize the control tree document to generate the control tree. As used herein, “control tree information” refers to the information or instructions within the control tree document that can be utilized to create a control tree.

In an embodiment, a new file representing a subsection of a portal can be generated from a stored template. The template may be stored with the portal. When the new file is created, configuration information for elements within the portal is created in the new file. When new elements are added to the subsection, the template information is utilized to organize the element.

While the present invention is described with reference to an embodiment in which control tree information, subsection information and the like are persisted as files, the present invention is not limited to the use of files and may be practiced using other persistence mechanisms, i.e., databases, relational, object and others, in memory data structures, objects, distributed objects and the like without departing from the scope of the embodiments claimed.

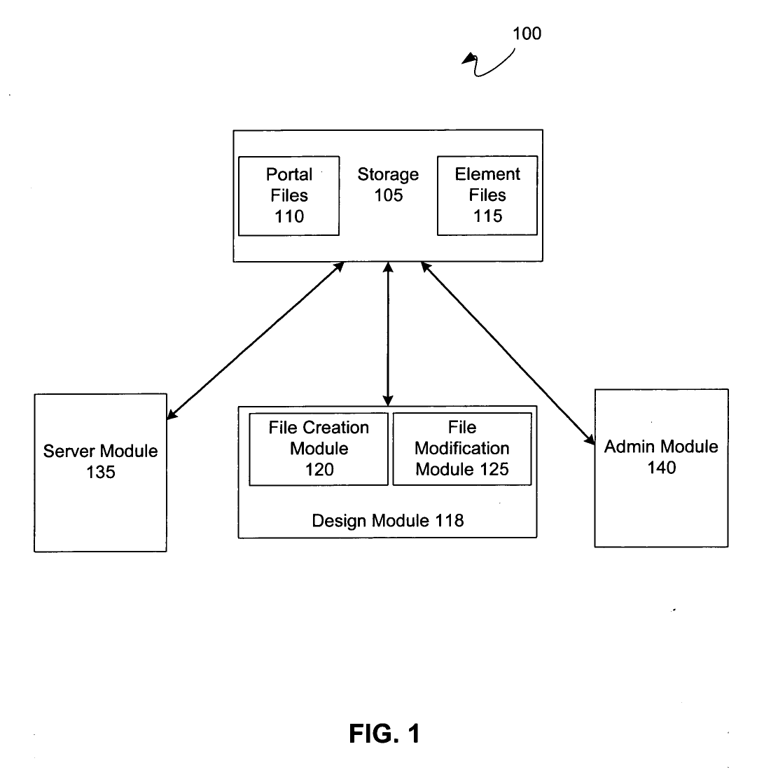

FIG. 1 illustrates an overview of example portal design architecture in an embodiment. As shown in FIG. 1, example portal design architecture 100 includes storage 105 that can interact with a server module 135, a design module 118, and an admin module 140.

The storage 105 contains files that are accessed by the server module 135 to serve the web portal to users accessing the server. The storage 105 stores one or more portal files 110. A portal file 110 is a control tree file storing the settings and content for a web portal. A portal file 110 can be arranged hierarchically and include information for at least one desktop. Desktops are customized views or presentations of a portal and are described further below with reference to FIG. 2. While the portal files are referred to as portal files or control tree files, in alternate embodiments, other persistence mechanisms and/or storage formats, i.e., databases, data structures, objects, distributed objects and the like can be used. Additionally, while in a present example embodiment, each of the portal files 110 is stored as a single file that is organized hierarchically, in alternate embodiments, any number of configurations can be used. For example, in one embodiment a main portal file can be broken into several files that reference each other.

The storage 105 also includes one or more element files 115. The element files 115 are files that are external to the portal files 110, but can be utilized to generate a portal by referencing element files 115 from within a portal file. The element files 115 typically include control tree information for various elements or groups of elements within a web portal. For example, one element file might include control tree information for a book and another might include control tree information for a page. The structure of the portal and the control trees generated in one embodiment is discussed below with reference to FIG. 2. The element files can include files for books, pages, or other elements or subsections of the portal.

The admin module 140 can be used to administer the portal. The admin module can be used to modify user and resource permissions and page configurations. In some embodiments, the admin module 140 can be used to perform layout and design functions for the portal.

The design module 118 can be used to create and modify content within the portal files 110 and the element files 115. The design module includes a file creation module 120 and a file modification module 125. In one embodiment, the design module is WebLogic® Workshop by BEA Systems of San Jose, Calif. The file creation module 120 is used to create new portal files 110 and new element files 115. The file modification module 125 is used to modify the portal files 110 and element files 115.

FIG. 2 illustrates a structure of an example portal in an embodiment. The example portal 202 shown by FIG. 2 can be a web application running on the server 135 of FIG. 1. A web application represents a collection of resources and components that can be deployed as a unit in one or more web/application servers. In one embodiment, a web application can represent a J2EE (Java 2 Platform, Enterprise Edition) Enterprise Application. (Java™ is a trademark of Sun Microsystems, Incorporated). From an end-user perspective, a portal is a website whose pages can be navigated. From an enterprise perspective, a portal is a container of resources and functionality that can be made available to end-users. Portals can provide a point of access to applications and information and may be one of many hosted within a web/application server. In one embodiment, a portal can be a J2EE application consisting of EJB (Enterprise Java Bean) components and a set of Web applications. In another embodiment, a portal can be defined by an XML control tree file. The control tree file can contain information for generating all of the components that make up that particular instance, such as books, pages, portlets, and look and feel components.

A portal taxonomy can be presented as a control tree generated from a control tree file. In one embodiment, each node in the control tree can be a subclass of a Control class in an object-oriented paradigm. A control tree can be created with both statically created controls and dynamically created controls. Statically created controls are created during a construction (or “wire-up”) phase of the control tree and, in one embodiment, can be based on static markup. Dynamically created controls are created during a control tree lifecycle, many times in reaction to state, context, and events.

One embodiment provides a set of controls for managing elements within a web application. As used herein, “control” is a computational entity that represents graphical and functional elements within a web application. Controls can have properties that can be read and set, and controls can interact with each other through an event notification mechanism. In addition to properties and events, controls can also have methods which provide services and which may be overridden to provide specialization of the control. In one embodiment, a control can be implemented as one or more classes in an object-oriented programming paradigm. Such an arrangement allows for new properties, events and/or specialized control methods to be provided by extending base control classes related to these features. In a framework, controls can also serve as containers for other controls. By way of a non-limiting example, a page may contain a book and a portlet, the book may contain one or more pages, the portlet may contain a window, the window may contain a title bar which may contain a close button, etc.

In various embodiments, a web application can contain one or more controls 202 representing one or more portals. A Graphical User Interface (GUI), for example, can contain one or more desktop controls 204. A desktop control in turn can contain one or more personalized views or user views (not shown). A user can have one or more personalized user views of a desktop. In one embodiment, a user view can result from customizing the layout, content, number, and appearance of elements within a desktop. A default user view can be provided for users who have not yet customized a desktop. A desktop's appearance can be determined by a Look and Feel control 210. The look and feel control can contain a skin component 220 and a skeleton component 222. While in the present embodiment the skin component 220 and skeleton component 222 are stored in separate nodes of the tree, in alternate embodiments they can be located in a single node. Skin component 220 can provide the overall colors, graphics, and styles used by one or more components in a desktop interface. In one embodiment, skin component 220 can include collections of graphics and cascading style sheets (CSS) that allow changes to be made to the look and feel of the GUI without modifying other components directly. References to images and styles can be made in the skin component 220 rather than being hard-coded into a GUI definition. A look and feel component 210 can provide a path to a skin component 220 directory to be used.

The look and feel component 210 can also provide a path to the skeleton component 222 directory to be used. In an embodiment, each type of component, from a desktop to a portlet's title bar, can have an associated JSP (Java ServerPages™) file, called a skeleton file, which renders it. For example, each desktop uses a skeleton file called shell.jsp that simply provides the opening and closing <HTML> (Hypertext Markup Language) tags to render the desktop. A portlet title bar, on the other hand, can have a skeleton file called titlebar.jsp that is more complex. It contains Java calls to various windowing methods in the API, references the button graphics to use on the title bar, and determines the placement of title bar elements with an HTML table definition.

A desktop also can contain a book control 206. A book control represents a set of pages linked by a page navigator (menu 214) having a user selectable graphical representation (e.g., a series of tabs wherein each tab corresponds to a different page, a series of buttons, a menu, or other suitable means.) A book can provide an indication of the currently selected page through visual clues such as highlighting a currently selected tab, displaying text and/or graphics to indicate the current page, etc. Books can be nested to n levels. A book can optionally include a theme control 212. In one embodiment, a theme control represents a subset of a skin component and can provide a way of using a different set of styles for individual desktop components. The book control can also contain other books 216.

A shell control 208 can render things surrounding the book 206 in the desktop 204. For example, a shell control might render a desktop's header and footer. These areas usually display such things as personalized content, banner graphics, legal notices, and related links.

A book 206 also contains zero or more page controls 218. A page control can represent a web page in an embodiment. A page is an area of a GUI upon which other elements having GUIs, such as books and portlets, can be placed. Pages can also contain books and other pages, and can be identified/navigated to by a control such as a menu 214. A page control can hold a theme control 224 and a layout control 226. A layout control 226 determines the physical locations of portlets and other elements on a page. In one embodiment, a layout is can be implemented as an HTML table.

A layout can contain a placeholder control 228 that is comprised of individual cells in a layout in which portlets are placed. A placeholder can contain zero or more books 232 and zero or more portlets 230. A portlet is a self-contained application that can render its own GUI. A portlet is a self-contained application that is responsible for rendering its own content on a page. By way of a non-limiting example, a portlet might be a display of current news headlines, wherein if a user selects a headline the portlet retrieves and the underlying story and displays it for the user. Portlets can communicate with other portlets and with back-end processes such as legacy software, databases, content management systems, enterprise business services, etc. In addition, multiple instances of a portlet can execute simultaneously. A portlet can also contain a theme 234.

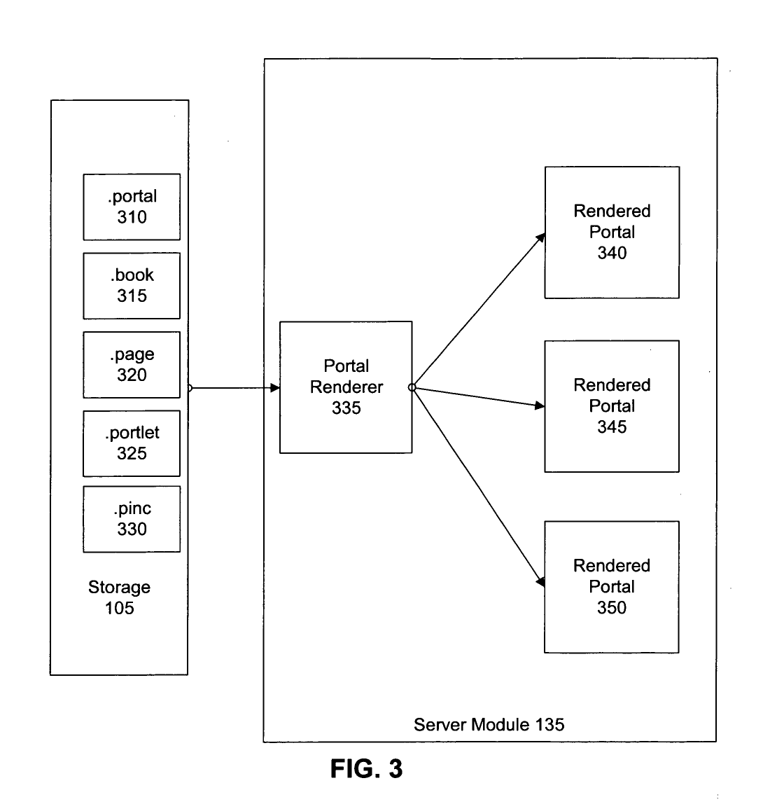

FIG. 3 illustrates an embodiment of a system for serving a portal. The storage 105 stores multiple portal and element files that are rendered by a portal renderer 335. The portal files are control tree files that contain information for a portal. The element files include .book 315, .page 320, portlet 325, and .pinc 330 files. These files are self-contained files that contain control tree information for different sections of a portal that, when parsed and utilized by the portal renderer 335, can be used to generate controls for the portal. In one embodiment, the portal and element files are XML documents. While only one of each is illustrated herein, those skilled in the art should understand that multiple instances of each file type can be present.

The portal renderer 335 is responsible for utilizing the .portal file 310 and element files 315, 320, 325, 330 from the server storage 105 to generate the rendered portals 340, 345, 350. The portal renderer 335 includes an XML parser that can read the files and generate a control tree.

In one embodiment the portal renderer 335 is a servlet residing on the server 135. When a request is received for a .portal file, the portal renderer can parse the XML in the .portal file to generate a rendered portal, which is then served to a client. The rendering process involves the generation of the control tree for the portal, thus enabling the rendered portals 340, 345, 350 to be accessed from a client browser.

When rendering the portal, the portal renderer 335 may also utilize the control tree information from the element files 315, 320, 325, 330. A .portlet file 325 contains XML code that when utilized by the portal renderer creates a portlet in a page. A .page file 320 is an XML document containing the control tree information for generating a single page within the portal hierarchy. It includes the structure and organization of the page. The following is an example of a .page file:

<?xml version=“1.0” encoding=“UTF-8”?>
<portal:root xmlns:netuix=“http://www.bea.com/servers/netuix/xsd/controls/netuix/1.0.0”

xmlns:html=“http://www.w3.org/1999/xhtml-netuix-modified/1.0.0”
xmlns:xsi=“http://www.w3.org/2001/XMLSchema-instance”
xmlns:portal=“http://www.bea.com/servers/netuix/xsd/portal/support/1.0.0”
xsi:schemaLocation=“http://www.bea.com/servers/netuix/xsd/portal/support/1.0.0 portal-support-

1_0_0.xsd”>

<netuix:page markupType=“Page” markupName=“page” definitionLabel=“pagePage1_dl” title=“.page

1”>

<netuix:content>

<netuix:gridLayout markupType=“Layout” markupName=“singleColumnLayout” columns=“1”>

<netuix:placeholder markupType=“Placeholder” markupName=“placeholder” flow=“vertical”>

<netuix:portletInstance

contentUri=“/common/portlets/genericPortlet/GenericPortlet.portlet” instanceLabel=“dotPagePortlet1”
markupType=“Portlet” title=“.page Portlet 1 (Generic)”/>

</netuix:placeholder>

</netuix:gridLayout>

</netuix:content>

</netuix:page>

</portal:root>

A .book file 315 includes the controls and information for serving a book. The .book file can include control tree information for each of the pages in the group of pages referenced by the book or include references to external .page files. The following is an example of a .book file.

<?xml version=“1.0” encoding=“UTF-8”?>
<portal:root xmlns:netuix=“http://www.bea.com/servers/netuix/xsd/controls/netuix/1.0.0”

xmlns:html=“http://www.w3.org/1999/xhtml-netuix-modified/1.0.0”
xmlns:xsi=“http://www.w3.org/2001/XMLSchema-instance”
xmlns:portal=“http://www.bea.com/servers/netuix/xsd/portal/support/1.0.0”
xsi:schemaLocation=“http://www.bea.com/servers/netuix/xsd/portal/support/1.0.0 portal-support-

1_0_0.xsd”>

<netuix:book markupType=“Book” markupName=“book” definitionLabel=“pincBookSub1”

defaultPage=“pincBookSub1_1” title=“title”>

<netuix:singleLevelMenu markupType=“Menu” markupName=“singleLevelMenu”/>
<netuix:content>

<netuix:pageContent contentUri=“/pinc/page1.page”/>
<netuix:pageContent contentUri=“/pinc/page2.page”/>

</netuix:content>

</netuix:book>

</portal:root>

A .pinc file 330 represents a subsection of a portal and can include control tree information for a subsection of a portal. A .pinc file is organized similarly to a .portal file, but does not include root elements and controls like a .portal file. A .pinc file includes a book or a page as its root element. In some embodiments, a pinc file is a general type of a .book or .page file, and is capable of functioning in the place of either.

A .portal file 310 contains control tree information that when utilized creates a portal instance. The .portal file 310 can also be referred to as a control tree file. The .portal file is organized hierarchically, in the manner illustrated in FIG. 2. Thus, within the .portal file, child elements within the hierarchy are located under their respective parents. For example, the control information for a book within a desktop can be located near the control information for the desktop and control information for a page in a book can be located near the book. In some embodiments, the control information for different elements of the portal can be located within the .portal file itself. Alternately, the .portal file can include references to external .book, .page, and .pinc files, that when detected cause the portal renderer to utilize the control information in those files as if it had appeared in the .portal file itself. The following is an example of a .portal file that contains a reference to an external .book file:

<?xml version=“1.0” encoding=“UTF-8”?>
<portal:root xmlns:portal=“http://www.bea.com/servers/netuix/xsd/portal/support/1.0.0”
xmlns:netuix=“http://www.bea.com/servers/netuix/xsd/controls/netuix/1.0.0”
xmlns:xsi=“http://www.w3.org/2001/XMLSchema-instance”
xsi:schemaLocation=“http://www.bea.com/servers/netuix/xsd/portal/support/1.0.0 portal-support-
1_0_0.xsd”>

<netuix:desktop title=“.book and .page Portal” markupType=“Desktop” markupName=“desktop”

definitionLabel=“dotBookAndDotPage_dl”>

<netuix:lookAndFeel definitionLabel=“lookAndFeelLabel” markupType=“LookAndFeel”

markupName=“defaultLookAndFeel” />

<netuix:shell markupType=“Shell” markupName=“headerFooter”>

<netuix:head />
<netuix:body>

<netuix:bookContent contentUri=“/pinc/book.book”/>

</netuix:body>

</netuix:shell>

</netuix:desktop>

As indicated above, the .portal file can include references to the element files 315, 320, 325, 330. Additionally, each of the element files can include references to other element files. Upon detecting a reference to an element file in a portal or element file, the portal renderer 335 can extract the element file and utilize the data stored in the file as if it had appeared in the referencing file for the purposes of creating the control tree.

The portal file 310 includes a set of templates that are used for the creation of new elements. It includes standard skeletons, layouts, looks and feels, and other base properties for new elements that are created within the portal. For example, the template could include a template page with structure and layout, but no content that could be used for the creation of new pages. Similarly, a template book could include a navigation menu with several template pages. The navigation menu and template pages could then be “filled” in with text and graphics and portlets.

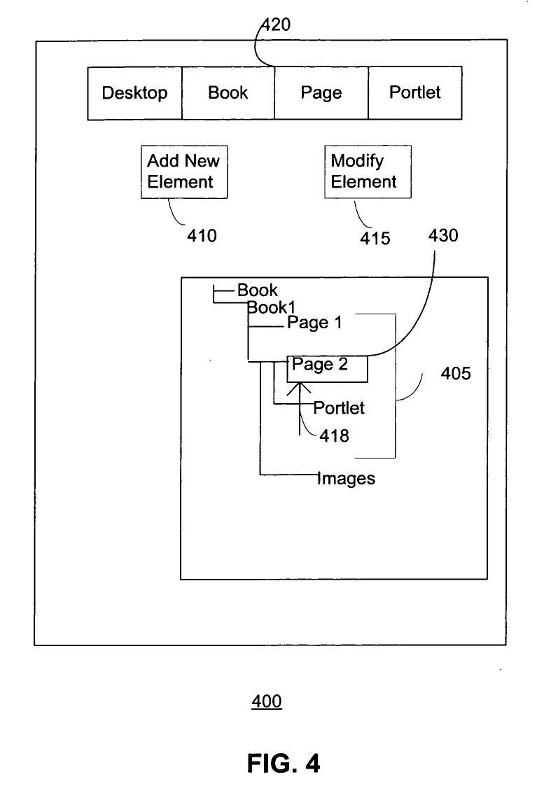

FIG. 4 illustrates a graphical user interface for generating and modifying portal content in an embodiment. While the present arrangement of selectors and configuration tools is used for illustrative purposes, those skilled in the art will understand that in other embodiments, alternate arrangements such as other graphical user interfaces, touchscreens, voice command systems, or any other arrangement can be used. This interface is preferably generated by the design module 115 or the admin module 140.

A main viewing window 400 includes a hierarchy window 405, selectors for adding a new element 410 and modifying an element 415, and a set of hierarchy selectors 420 that can move the interface to a certain level in a hierarchy. In one embodiment, this editor is used to modify or create a .portal file, such as the one described above with reference to FIG. 3.

The hierarchy window 405 can present an organization of the portal, represented as a graphical hierarchy of elements. By using a pointing indicator 418, an element within the hierarchy can be selected or highlighted, thus producing a selection indicator 430. When an element is selected, operations utilizing the selectors 410, 415 can be performed on the selected element.

A new element selector 410, when selected, can generate a new element, such as a book, page, or portlet, below a currently selected element in the portal hierarchy. A user may be prompted at this point as to whether the new element is created in a separate element file, such as those described with reference to FIG. 3 or a .portal file representing the entire portal. Upon selection of this command a new element file (e.g. .pinc, .book, .page) can be created in the storage 105 and a reference to the element can be generated in the .portal file.

A modify element selector 415 can open an editor specifically pertaining to the selected element. In some embodiments, the editor is integrated within the main window, in alternate embodiments, the editor is a separate window. This causes the appropriate element file to be opened, with any changes saved within the element file or the portal file.

A series of hierarchy selectors 420 enable the portal hierarchy to jump to a particular level within the hierarchy. In some embodiments, the selectors 420 include the titles of specific elements and selection of one of the selectors 420 cause an editor to be opened for the selected elements. While in the present embodiment, only a single element is illustrated for each level, in alternate embodiments, multiple elements can be illustrated at each level of the hierarchy. The selectors can jump to both elements that are stored within the main .portal file and elements that are stored externally.

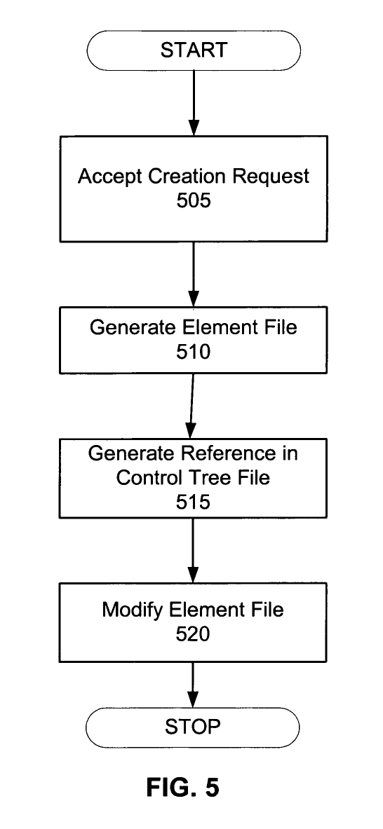

FIG. 5 is a flow chart illustrating a process for generating a file containing a portal element in an embodiment. In one embodiment this process is performed by the file creation module 120 and the file modification module 125. In block (505) the system accepts an element creation request. In one embodiment, this request is submitted through the interface illustrated in FIG. 4 and is presented when a .portal file is being edited.

In block (510) an element file is generated. This step entails the generation of a .book file, .page file, .pinc file, or any other element file. The generated file contains control tree information that can be rendered by the portal renderer 335 to create the corresponding element within the portal. In block (515) a reference to the external file is stored in the .portal file. The reference can be inserted at a location where the control tree information for the element would otherwise be stored. The system may utilize a template for creating the element.

In block (520) the element file is modified. This step can be achieved through the interface illustrated in FIG. 4 or through a separate editor. This can entail modifying settings within the element file, or adding a new sub-element within the element.

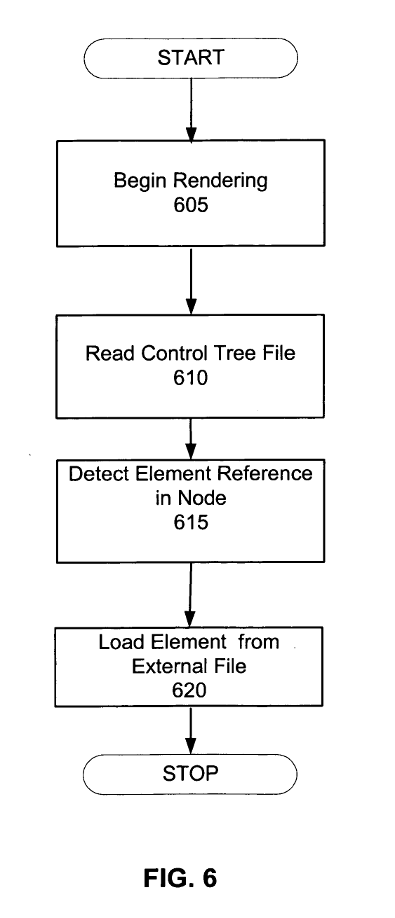

FIG. 6 is a flow chart illustrating a process for serving a portal from a control tree file in an embodiment. In one embodiment this process is performed by the portal renderer 335 of FIG. 3. This process can be performed when a request is received for a .portal file or some part of the portal. In block (605) the system begins generation of the portal. During this step a command is transmitted to the portal renderer indicating a control tree file that should be used to generate the requested portal. The selected file is parsed to generate a control tree from the contents of the XML document. In some embodiments, the hierarchy of the XML document is organized in a manner that parallels the organization of the portal.

In block (610) the control tree file is read. Reading the control tree file includes assembling the control tree for the portal from the control tree information stored in the XML document, which includes settings for different levels of the portal hierarchy, and control information for each of the elements. In block (615) a reference to the external element is detected in the control tree file. In some embodiments, the reference is located at a similar location to where the information for the element would have been stored if it were part of the control tree file.

In block (620) the external element file is extracted. The information stored in the external element file is used to generate the section of the control tree described in the external element file. The element is now part of one of the rendered portals 340, 345, 350 and otherwise functions similarly to an element that was described in the control tree file.

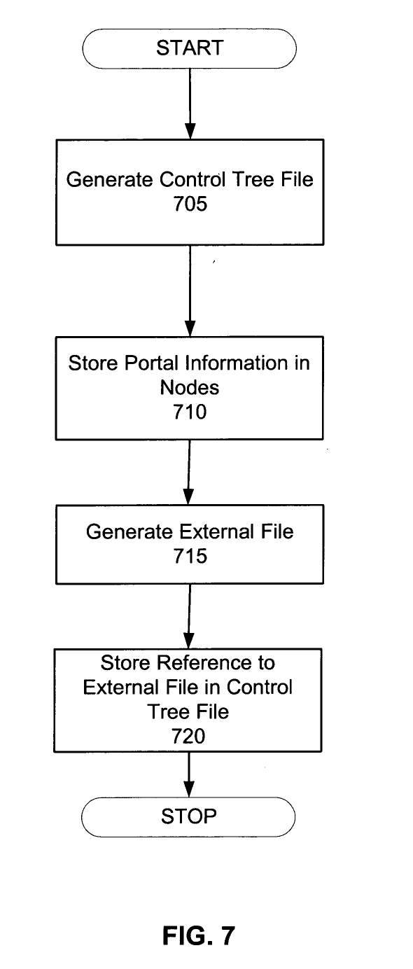

FIG. 7 is a flow chart illustrating a process for generating a control tree file referencing external files in an embodiment. This process can be performed by the file creation module 120 and the file modification module 125. In block (705) a control tree file is generated. Generating a control tree file comprises creating a document such as a .portal file or other document type. In some embodiments, the control tree file is an XML file. In some embodiments, the control tree file can be created through the use of a graphical user interface.

In block (710) portal information is stored in the nodes of the control tree file (i.e., the sections corresponding to different controls). In some embodiments, the control tree file is organized in a manner parallel to the organization of the portal, with the configuration information for portal-wide resources stored initially and information for the differing levels of the portal hierarchy stored subsequently. For example, desktop settings might follow portal-wide settings, with book settings for a particular desktop included below desktop-wide settings. Similarly, page settings would be stored near the setting of whichever book the page was a part of.

In block (715) an external file is generated for the portal element. This file can be named according to the element described therein, with a file representing a book having a .book extension or a file representing a page having a .page extension. The file can include menus, configuration settings, and all other information for generating the controls for the web portal. The element file is preferably stored with the .portal file so that it can be rendered when the .portal file is rendered.

In block (720) a reference to the external file is stored in the control tree file. The reference is preferably stored in a location or node where the control tree information for the element would have been stored were it directly included in the control tree file. The reference can include an absolute location of the external file, or a reference relative to the control tree file. The external file can then be used for the generation of the portal as illustrated by FIG. 6.

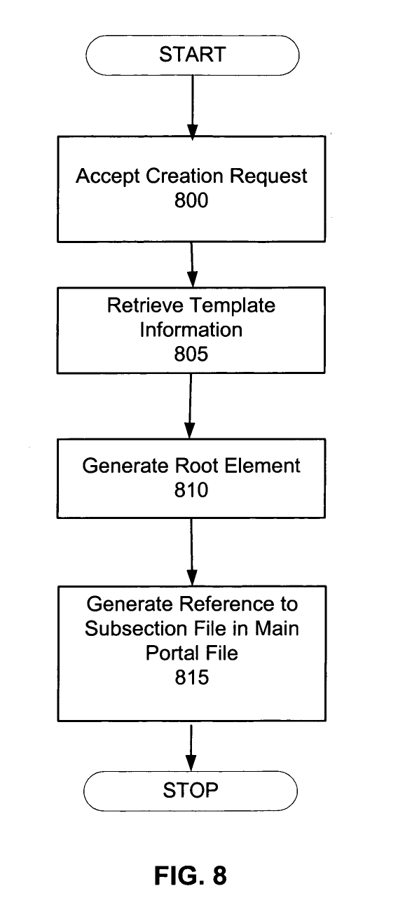

FIG. 8 is a flow chart illustrating a process for generating a file for a subsection of a portal in an embodiment. In one embodiment this process can be performed by the admin module 140. In some embodiments the process is performed through the interface illustrated in FIG. 4. In block (800) a creation request is received. In one embodiment, a selection of the new element button 410 can cause a subsection to be created. In some embodiments, the subsection file is a .pinc file. In block (805) template information is retrieved from the main .portal file. The template information includes, but is not limited to a standard look and feel for the element, a standard skeleton and menu/layout arrangement, and a default page arrangement for books. The template information is presented in the form of control tree information for generating a template version of the element.

In block (810) a root element is created in the subsection file. The root element is typically the element that is requested in block (800). The root element for a subsection file can be a book or a page. In block (815) a reference to the newly generated subsection file is stored in the main control tree file for the portal. The reference is configured to enable the subsection file to be integrated into the portal when it is rendered as if the content of the subsection file were stored in the main portal file. The subsection file can also be used to accept the creation of new elements, which can then be stored in the subsection file.

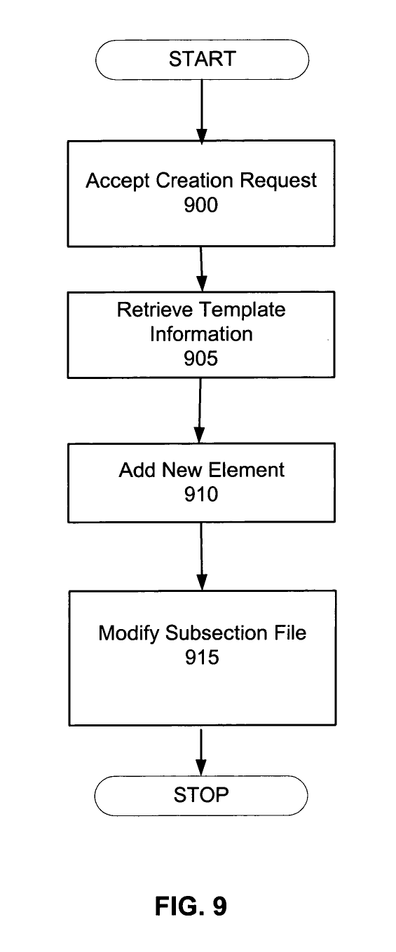

FIG. 9 is a flow chart illustrating a process for modifying a subsection of a portal by creating a new element in a subsection file in an embodiment. In some embodiments the subsection file is a .pinc file. In block (900) a creation request is accepted. In one embodiment this process can be performed by the admin module 140. In some embodiments the process is performed through the interface illustrated in FIG. 4. In some embodiments, this request is submitted through a “create new element” button when the subsection has been selected in the main viewing window. In block (905) template information is received for the element. The template information can include look and feel, skeleton structure, and layout information for the element. In block (910) the element is created. In block (915) the subsection file is modified to include the element. This step entails providing control tree information for the element within the subsection file.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention.

What is claimed:

1. A method for serving a web portal, the method comprising:
reading a control tree document for the web portal, the control tree document organized according to a hierarchy within the web portal, the control tree document comprising nodes corresponding to levels within the hierarchy;
detecting within a node associated with one or more associated pages of the web portal, a reference to an external entity, the external entity comprising information for serving the one or more associated pages; and
utilizing the external entity to serve the one or more associated pages within the web portal.

2. The method of claim 1, wherein the external entity comprises a definition of a book.

3. The method of claim 1, wherein the external entity comprises a definition of a page.

4. The method of claim 1, wherein the control tree document comprises an eXtensible Markup Language (XML) document.

5. The method of claim 1, wherein the external entity comprises an eXtensible Markup Language (XML) document.

6. The method of claim 1, wherein the external entity includes a reference to a second external entity.

7. The method of claim 1, wherein the external entity contains information for serving a single page.

8. A machine readable medium having instructions stored thereon that when executed by a processor cause a system to:
read a control tree document for a web portal, the control tree document organized according to a hierarchy within the web portal, the control tree document comprising nodes corresponding to levels within the hierarchy;
detect within a node associated with one or more associated pages of the web portal, a reference to an external entity, the external entity comprising information for serving the one or more associated pages; and
utilize the external entity to serve the one or more associated pages within the web portal.

9. The machine readable medium of claim 8, wherein the external entity comprises a definition of a book.

10. The machine readable medium of claim 8, wherein the external entity comprises a definition of a page.

11. The machine readable medium of claim 8, wherein the control tree document comprises an eXtensible Markup Language (XML) document.

12. The machine readable medium of claim 8, wherein the external entity comprises an eXtensible Markup Language (XML) document.

13. The machine readable medium of claim 8, wherein the external entity includes a reference to a second external entity.

14. The machine readable medium of claim 8, wherein the external entity contains information for serving a single page.

15. A system for serving a web portal, the system comprising:
a control tree document organized according to a hierarchy within the web portal, the control tree document comprising nodes corresponding to levels within the hierarchy; and
a portal renderer configured to:
detect within a node associated with one or more associated pages of the web portal, a reference to an external entity, the external entity comprising information for serving the one or more associated pages; and
utilize the external entity to serve the one or more associated pages within the web portal.

16. A method for serving a web portal, the method comprising:
reading a control tree file for the web portal, the control tree file organized according to a hierarchy within the web portal, the control tree file comprising nodes corresponding to levels within the hierarchy;
detecting within a node associated with one or more associated pages of the web portal, a reference to an external file, the external file comprising information for serving the one or more associated pages; and
utilizing the external file to serve the one or more associated pages within the web portal.
